(19) United States
(12) Patent Application Publication
(10) Pub. No.: US 2023/0412626 A1
(43) Pub. Date: Dec. 21, 2023

(54) SYSTEMS AND METHODS FOR CYBER SECURITY AND QUANTUM ENCAPSULATION FOR SMART CITIES AND THE INTERNET OF THINGS

(71) Applicant: LOURDE WRIGHT HOLDINGS, LLC, Warner Robins, GA (US)

(72) Inventor: Chasity Latrice Wright, Warner Robins, GA (US)

(21) Appl. No.: 18/164,234

(22) Filed: Feb. 3, 2023

Related U.S. Application Data
(63) Continuation-in-part of application No. 18/163,790, filed on Feb. 2, 2023.
(60) Provisional application No. 63/306,893, filed on Feb. 4, 2022.
(60) Provisional application No. 63/306,889, filed on Feb. 4, 2022.

(51) Int. Cl. H04L 9/40; H04L 41/16

(52) U.S. Cl. CPC H04L 63/1425; H04L 41/16

(57) ABSTRACT

Security systems and methods continuously monitor for known threats and proactively pursue information on emerging or unknown threats on devices and data. This disclosure relates generally to security systems for computing environments. More particularly, this disclosure relates to security systems for implementing a threat characteristic recognition and mitigation process in a computing environment, substantially as illustrated by and described in connection with at least one of the figures, as set forth more completely in the claims

### BACKGROUND

As technology becomes more integrated in everyday life, people may have a tendency to become reliant on their devices and data (e.g., stored on devices and/or accessible online). For instance, people may store sensitive or personal information on their devices without awareness of potential risks involved with storing such information on their devices, and/or may transmit, expose, and/or otherwise grant access to third parties to their data, which exposes the devices and data to a variety of threats. Thus, systems and/or methods that protect the data and devices is desirable.

### SUMMARY

This disclosure relates generally to security systems for computing environments. More particularly, this disclosure relates to security systems for implementing a threat characteristic recognition and mitigation process in a computing environment, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of a system for securing devices and data in a computing environment, in accordance with aspects of this disclosure.

FIGS. 2A-2C illustrate example malicious attacks, in accordance with aspects of this disclosure.

FIGS. 3A-3H illustrate example ransomware issues and solutions, in accordance with aspects of this disclosure.

FIG. 4 illustrates an example of secure password storage issues, in accordance with aspects of this disclosure.

FIGS. 5A-5D illustrate examples of systems leveraging blockchain and smart contracts, in accordance with aspects of this disclosure.

FIG. 6 illustrates an example of performing security system verification and validation, in accordance with aspects of this disclosure.

FIGS. 7A and 7B illustrate example malicious attacks, in accordance with aspects of this disclosure.

FIG. 8 illustrates an example of trusted platforms, in accordance with aspects of this disclosure.

FIGS. 9A and 9B illustrate example quantum security applications, in accordance with aspects of this disclosure.

FIG. 10 illustrates an examples of cryptography, in accordance with aspects of this disclosure.

FIG. 11 illustrates an example flowchart of a facial recognition process, in accordance with aspects of this disclosure.

### DETAILED DESCRIPTION

Disclosed example systems and methods for a security system for implementing a threat characteristic recognition process in a computing environment are provided. In particular, disclosed example security systems are configured to monitor data traffic at one or more access points of the computing environment; provide the data to the security system as an input for analysis; identify one or more characteristics of the data traffic; compare the one or more characteristics of the data traffic to characteristics stored on one or more databases corresponding to suspicious or malicious behavior; determine if the features are unauthorized actions or from an unauthorized actor based on the characteristics; and prevent access to the system or transmission of the data if the one or more characteristics match with the characteristics stored on the one or more databases.

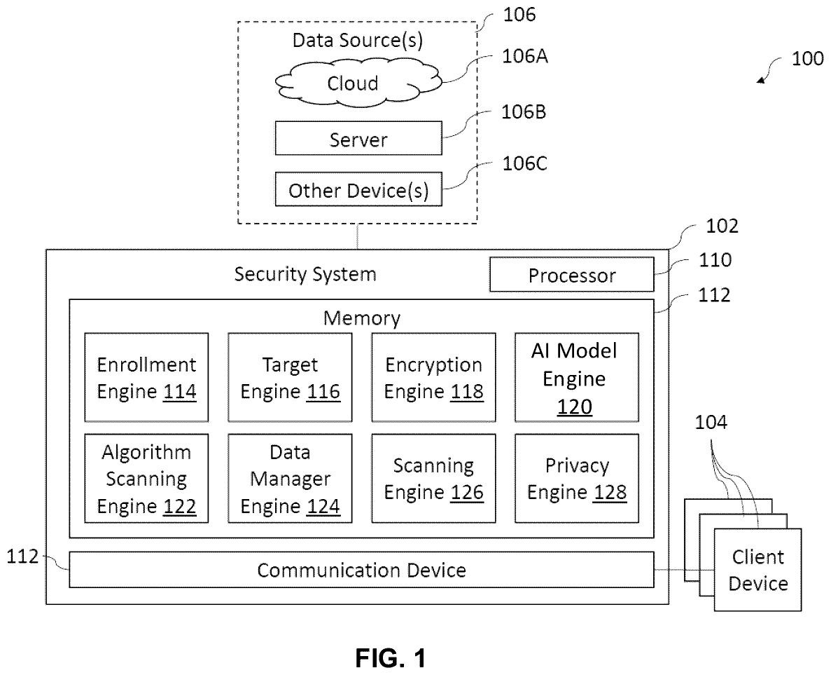

Referring to FIG. 1, depicted is a system 100 for securing devices and data in a computing environment. The system 100 includes a security system 102, a plurality of client devices 104, and a plurality of data sources 106. The data sources 106 may be or include any device(s), component(s), application(s), and so forth, which may deliver, transmit, or otherwise provide data to a client device 104. The data sources 106 may include cloud-based data sources 106A, server based data sources 106B, and other client devices 106C. The data sources 106 may communicably couple to the client devices 104 via a network (e.g., a Local Area Network (LAN), Wide Area Network (WAN), Wireless Local Area Network (WLAN), Metropolitan Area Network (MAN), Cellular Network (e.g., 4G, 5G, etc.), and so forth). The security system 102 may be configured to intercept outbound and inbound data for the client devices 104 via a communication device 108. In some embodiments, the security system 102 may be embodied on the client device 104. In some embodiments, each of the client devices 104 may include a separate security system 102. In still other embodiments, a group of client devices 104 may be members of a single security system 102. In some examples, the client devices 104 are internet of things (IoT) enabled devices.

The communication device 108 may be any device(s), component(s), sensor(s), antenna(s), or other element(s) designed or implemented to provide or facilitate communication between two or more devices (such as the data source(s) 106 and client device 104. In some embodiments, each of the security system 102, client device(s) 104, and data source(s) 106 may include respective communication device(s) 108 such that each of the security system 102, client device 104, and data source(s) 106 may be configured to communicate with one another.

The security system 102 may be embodied as or include a processing circuit which includes a processor 110 and memory 112. The processor 110 may be a general purpose single or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. The processor 110 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The memory 112 (e.g., memory, memory unit, storage device) may include one or more devices (e.g., RAM, ROM, EPROM, EEPROM, optical disk storage, magnetic disk storage or other magnetic storage devices, flash memory, hard disk storage, or any other medium) for storing data and/or computer code for completing or facilitating the various processes, layers and circuits described in the present disclosure. The memory 112 may be or include volatile memory or non-volatile memory, and may include database components, object code components, script components, or any other type of information structure for supporting the various activities and information structures described in the present disclosure. According to an illustrative embodiment, the memory 112 is communicably connected to the processor 110 via a processing circuit and includes computer code for executing (e.g., by the processing circuit or the processor 110) the processes described herein.

The system 100 may be deployed in various computing environments for various industries including, for instance, healthcare, finance, military or defense, avionics, quantum systems, as a listing of non-limiting examples. For example, any individual or entity who employ networked devices to traffic in data can benefit from the protections to data and devices provided by the disclosed security system. Furthermore, the system 100 may allow users of a client device 104 to operate the client device 104 “as normal,” while still protecting the users from known, unknown, and/or potential or emerging threats in various computing environments.

The memory 112 may store various engines or be comprised of a system of circuits. The circuits may include hardware, memory, and/or other components configured or implemented to execute various functions. Various operations described herein can be implemented on computer systems.

The memory 112 is shown to include a target engine 116. The target engine 116 may be any device, component, processor, script or application designed or implemented to identify known or potential risks in a computing environment. The target engine 116 may be a manager of generated targets, which are constructed to represent real users. The target engine 116 may manage a plurality of generated targets. Each of the generated targets may be created for drawing or capturing data intrusions, bad or malicious actors, malware, or other entities/software/programs/etc. (collectively referred to as “threats”) which may implicate or breach a user's data. Each of the targets may transport the threats to a safe, diversion or testing environment (e.g., within the target engine 116 or external to the security system 102) to analyze the type of action the threat would execute (e.g., access financial data, offload confidential files, copy emails or text messages, etc.). The target engine 116 may be designed or implemented to generate a report describing each action of threats identified and corresponding to the managed targets.

The memory 112 is shown to include an encryption engine 118. The encryption engine 118 may be any device, component, processor, script or application designed or implemented to encrypt various data. The encryption engine 118 may be configured to encrypt data using various encryption protocols to protect data and/or devices in the environment.

The encryption engine 118 may be configured to encrypt, encode, or otherwise hash Addresses associated with client devices 104. In some embodiments, the encryption engine 118 may be configured to hash Bluetooth mac addresses, IP addresses, or other addresses associated with each of the client devices 104 associated with an enrolled user. The encryption engine 118 may be configured to assign, modify, or otherwise replace the manufacturer information with the generated hash(es) throughout ownership of the client device 104 (e.g., unless the client device 104 changes ownership or the client device 104 is destroyed). The encryption engine 118 may be configured to detect missing encryption certificates and missing encryption certificate validation. As such, the encryption engine 118 may be configured to generally monitor for proper encryption certificates for data, devices, or other aspects of the system 100.

The memory 112 is shown to include an artificial intelligence (AI) model engine 120 to build an AI or machine learning (ML) model based on accessed data sets stored in the data sources 106.

The memory 112 is shown to include an algorithm scanning engine 122. The algorithm scanning engine 122 may be any device, component, processor, script or application designed or implemented to monitor, adjust, change, identify, or otherwise scan algorithms used by other devices. The algorithm scanning engine 122 may be configured to scan algorithms as a manner of validating the algorithms, determining a viability or deficiency of the algorithms, etc. In some embodiments, the algorithm scanning engine 122 may be configured to scan algorithms used to identify characteristics of a malicious actor.

In some examples, the algorithm scanning engine 122 may be configured to detect if particular characteristics or markers of a user (e.g., social, physical, behavioral, etc.) are being used by a third party to gain access to a secured network or device for which the user has authorization to access.

The memory 112 is shown to include a data manager engine 124. The data manager engine 124 may be any device, component, processor, script or application designed or implemented to manage data rights, access, privileges, or other aspects of data.

The data manager engine 124 may be configured to monitor, identify, detect, or otherwise check for oversharing of data from a client device 104 across systems that contact the client device 104. The data manager engine 124 may be configured to create threat models per client device 104, data, network, etc. For example, threat models will be unique to each client device, data, incident, entity, and/or user. This is because each are different, provide different function, are exposed to different threats, and/or may be accessible to different users and/or networks, which necessarily presents different threats to the various systems, devices, data, and/or users.

The memory 112 is shown to include a scanning engine 126. The scanning engine 126 may be any device, component, processor, script or application designed or implemented to scan one or more devices, components, elements, and so forth which may be communicably coupled to or otherwise within range of a client device 104. The scanning engine 126 may be configured to scan IoT sensors (Ex. Smart Cities, Electric Car charging station sensors, Ultrasound sensors, sensors used to scan biometrics) for malware, dated firmware, and software.

The memory 112 is shown to include a privacy engine 128. The privacy engine 128 may be any device, component, processor, script or application designed or implemented to manage, handle, or otherwise process data access rights or other privacy rights for a client device 104. The privacy engine 128 may be configured to defend against insecure direct object reference (IDOR) vulnerabilities. IDOR vulnerabilities include a type of security flaw that is easy to exploit by permitting an attacker to gain access to other users' accounts simply by changing the value of a parameter in a request. The privacy engine 128 may be configured to offer (or automatically change) system generic passwords and send the passwords to the end user and/or update the user's client devices 104 with the password. The privacy engine 128 may be configured to detect reverse engineering and commands for guessing or determining an end users' password(s) by hackers.

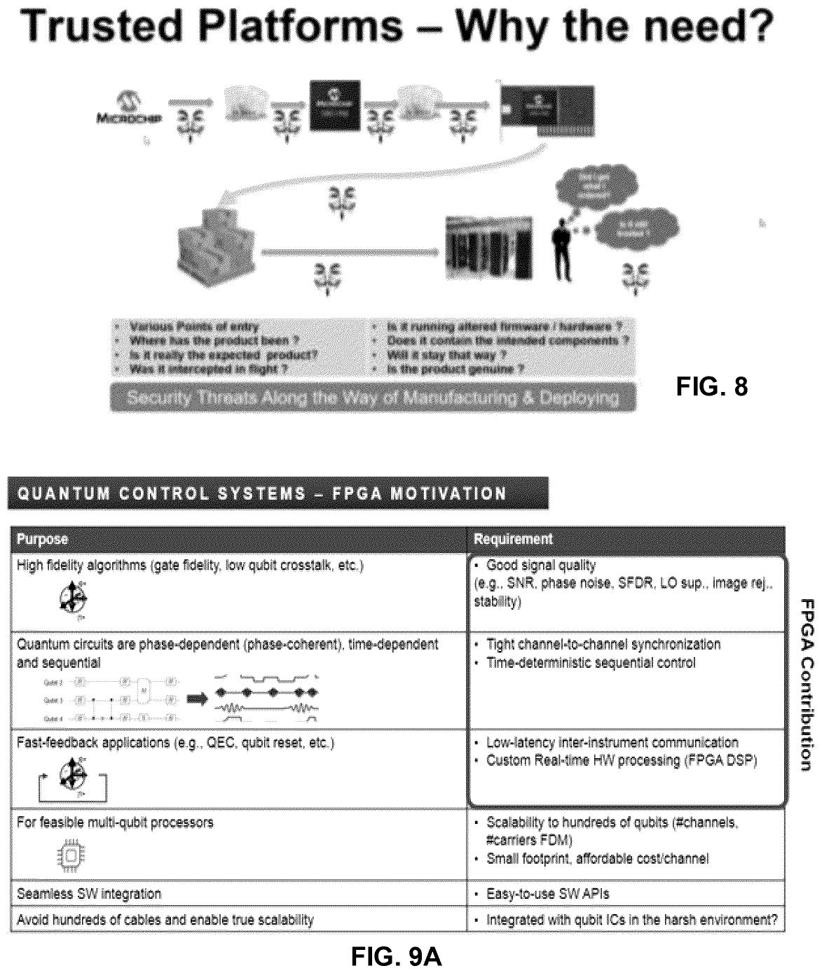

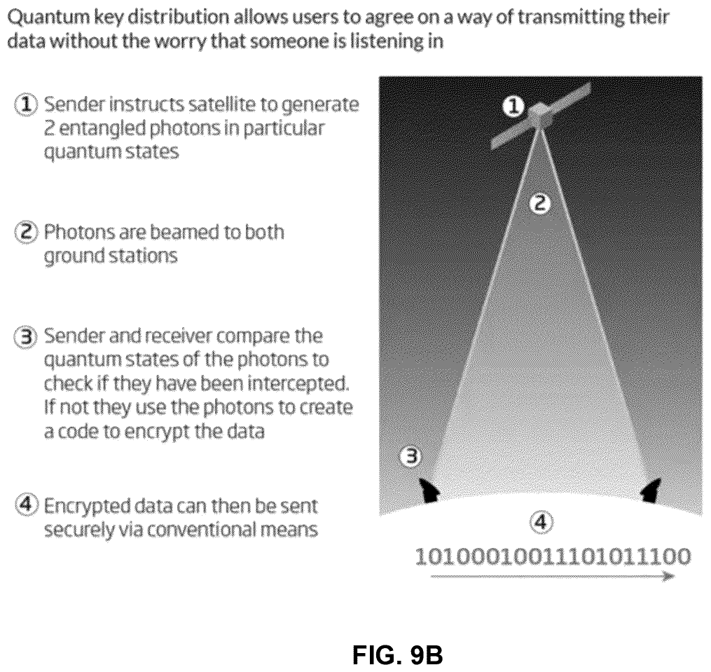

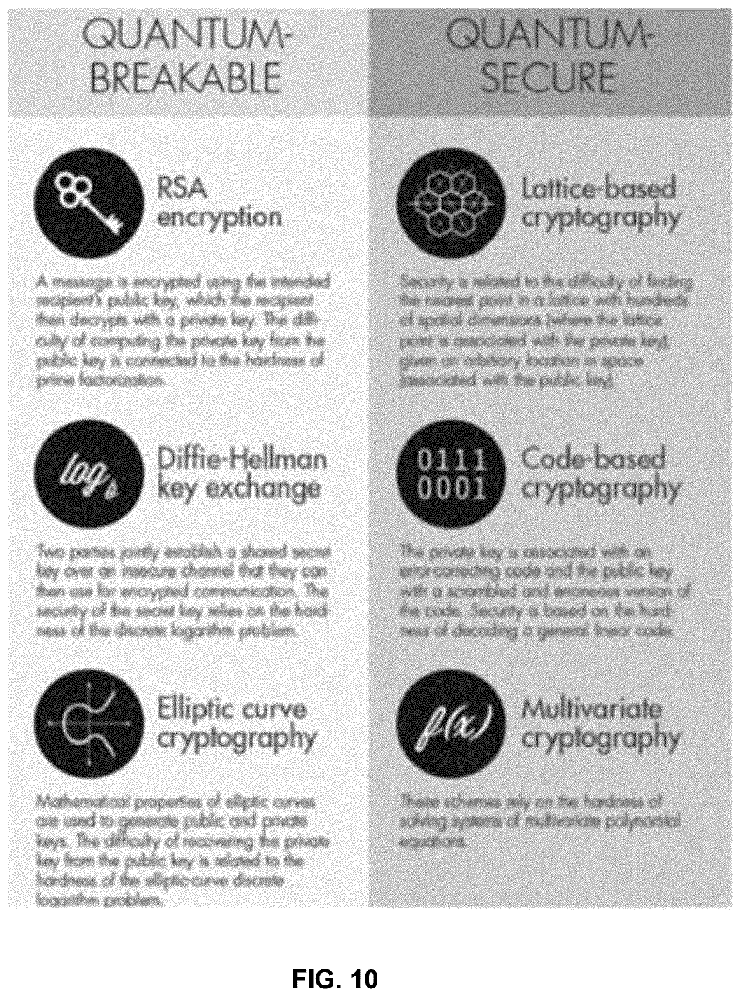

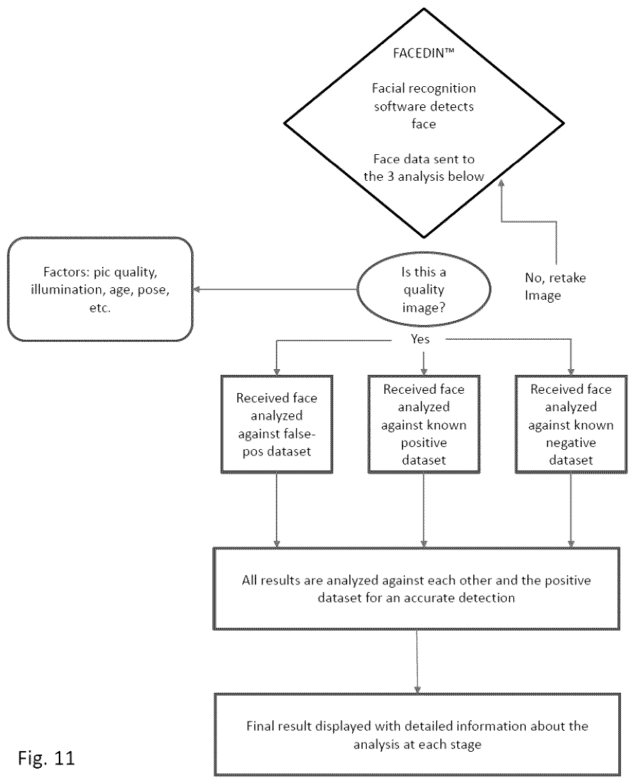

In some examples, the security system 102 operates as a quantum enabled computer, network, and/or device. Aspects of a quantum protection protocol, quantum-enabled security applications, and/or quantum-enabled hardware are disclosed herein, and with reference to example FIGS. 8B and 9.

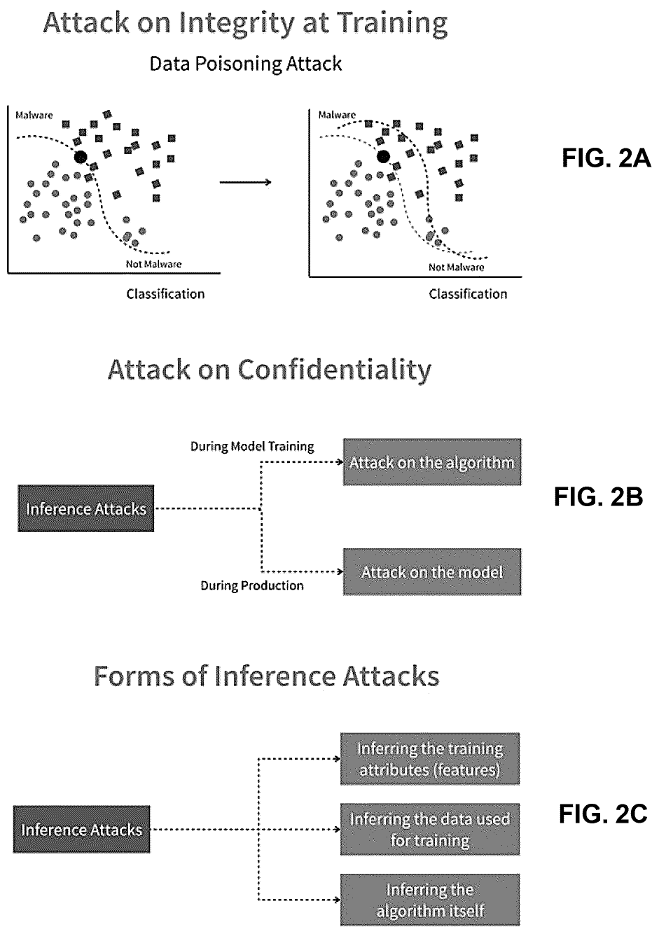

FIGS. 2 to 9 provide example implementations that may be executed by the example security system 102 of FIG. 1 to identify malicious activates and/or actors, and/or prevent access to unauthorized activities and/or actors, in accordance with aspects of this disclosure.

In some examples, consider the myriad application programming interface (API) breach endpoint-method permutations categories. The OWASP API Security Top 10 is a useful starting point. The disclosed examples provide solutions to the issues raised by several of these security issues. For instance, regarding Broken Object Level Authorization, are API users restricted in what data they can access from a protected system? Regarding Broken Authentication, do the systems employ strong authentication to ensure users are legitimate? Regarding Excessive Data Exposure, does the API only return needed (e.g., specifically requested) data? Or does the API return much more? Regarding a Lack of Resources and/or Rate Limiting, will the API allow users to query by an expansive, perhaps unnecessary, amount (e.g., the thousands, millions, etc.)? And regarding Broken Function Level Assignment, do users have the authority to execute any operation they want? Or are just those they need?

In some examples, the system maintains a regularly updated list of blocked entities (e.g., addresses, users, URLs, etc.). When a new user or device is introduced, the system scans the device and associated user, data, and/or software to ensure each is legitimate and authorized to access system data.

In some examples, a model is trained to recognize such entities. For instance, an unsupervised learning model can be produced to analyze access logs and/or login attempts, and find patterns of activities that can be indicative of suspicious behavior. Such problems fall into the category of so-called clustering problems. Clustering can group together algorithms and/or data that have similar characteristics.

In some examples, a clustering algorithm creates such groups without any manual oversight in an example of unsupervised learning, in contrast to classification of entities/data, which is a supervised learning task. Furthermore, a clustering problem can be separated into two or more use cases, such as pattern recognition and/or anomaly detection. In pattern recognition problems, the goal of the underlying algorithm (e.g., employing machine learning) is to discover groups with similar characteristics. Some examples of pattern recognition algorithms are K-means and/or self-organizing maps. For example anomaly detection problems, the goal of the underlying algorithm is to identify the natural pattern inherent in data and then discover the entity/data that deviates from expected and/or natural operation.

In some examples, the system includes a container protection feature. For example, a container can be a form of virtualization that virtualizes an operating system (rather than system hardware). In order to detect suspicious entities, program execution, and/or network activity, an unsupervised anomaly detection model is built by using file access data, network traffic information, and/or process maps as input data. Two example anomaly detection algorithms are Density-based spatial clustering of applications with noise (DBSCAN) and Bayesian Gaussian mixture models.

### Artificial Intelligence and System Security: Limitations and Poor Implementation

Machine learning (ML), by its nature alone, comes with limitations and dependencies. In addition, if implemented poorly security teams may make suboptimal (or wrong) decisions when protecting against threats. ML is probabilistic. ML algorithms, especially deep learning algorithms, do not have or maintain domain knowledge. ML algorithms are configured to understand underlying network topologies, physics, and/or business logic. These algorithms only access data at inputs and outputs in order to identify relationships between the data, without understanding of any meaning attached to these relationships. As a result, it is possible for a trained model (created based on input data) delivers one or more results that violate fundamental constraints of your environment.

When implementing AI, knowledge of the associated subject matter allows for deliberately adding constraints to built algorithms to ensure any such algorithms honor rules and/or logic applicable to an environment in which they operate. Some ML algorithms lack explainability. Thus, when an AI model identifies a pattern in a dataset or detects an anomaly, the AI model will not be able to explain the rationale behind the decision to group the data. In other words, without a supporting explanation, security teams are presented with challenges on how best to accept a recommendation or action.

A probabilistic system determines the probability of occurrence of an event, but there remains a degree of error associated with the probability. As a result, there is a possibility of false positives and/or false negatives within some recommendations made by an AI algorithm. Furthermore, ML has a dependency on large data sets for training, and in some cases on availability of labeled data. If such data, and/or the required quantifies of data, is unavailable (e.g., outside an organization; not from a trusted data source) to train the machine learning models, the quality and/or efficacy of the results are in question.

### Artificial Intelligence and System Security: Attack Against Your AI Implementation

Even if the model and implementation of the model meet desired criteria, the algorithm itself may be vulnerable to attacks, as illustrated in FIGS. 2A to 2C. Not just well-known attacks or vulnerabilities (such as buffer overflow, denial of service, man in the middle, phishing attacks, etc.), but dynamic and innovative attacks against ML algorithms and models at their core. In particular, by creating an AI-based system, different types of attack can surface within the data environment, opening up new ways of exploitation and abuse by the malicious actors.

Innovative attacks can manifest in the form of an attack on confidentiality, integrity, and/or availability of the AI system (e.g., the underlying datasets, the authentication of the ML/AI algorithms, authorization required to employ the algorithms, authentication of the algorithms' results, etc.). Attacks against the confidentiality of an AI system aim to uncover details of the algorithms being used. Once internals or underlying information supporting the algorithm are known to an attacker, the attacker can use this information to plan for more targeted attacks (such as inference attacks). An attacker can initiate an inference attack either at the time of training, which is considered an attack on the algorithm, and/or after the ML model is deployed, which can be considered an attack on the ML model.

Regardless of the stage where the attack is performed, the inference attack can take many different forms. For example, the inference attach can infer the attributes or features used to train the model, and/or infer the actual data used for training the model, and/or infer the algorithm itself. Once the attackers know the training data, attributes, and/or the algorithm itself, the attacker may extract confidential data (e.g., associated with the algorithm), as well as information to facilitate an attack on the integrity and/or the availability of the system.

Attacks on the integrity of an AI system aimed to alter the trustworthiness of its capability for the task it is designed to perform. For example, if the goal of the machine learning model is to classify users into malicious and genuine categories, an attack on the integrity will change the behavior of the model such that it will fail to classify the users correctly. As before, this type of attack could take place at the time of training, or in the production stage. Such an attack manifests in two different forms. First, as an adversarial data input by an attacker at the time of testing or production. Second, as a data poisoning attack by an attacker at the time of training. An attacker creates data input that looks valid but actually it is not. Then presents to the classifier model in production. Such raw data inputs are also known as adversarial or mutated inputs.

One example is the malware that goes undetected by a malware scanner. Under normal circumstances the new data would be correctly classified as malware as shown by the smiley face on the graph. However, an adversarial input fools the classifier such that the same data input is now classified as genuine. Of course, what is not obvious here is that the attacker had spent significant time to probe the model and understand its behavior to be able to come up with such an adversarial input. In the second form, the attacker contaminates the training data either at the time of training or during the feedback loop after the model is deployed to production. This is also known as a data poisoning attack. Under normal circumstances the new data would be correctly classified as malware, but with the data poisoning attack the model's behavior is modified such that the same input is now classified as genuine input.

Once such an attack is successful, the model is skewed. And its stored knowledge of the boundaries between the good and the bad is altered. This change is permanent unless the model is trained again with a clean and trustworthy training data. Attack on the availability axis takes many different forms as well. Using a technique known as adversarial reprogramming the attacker takes control of the model and makes the model perform a completely different task than it was designed to perform. This attack renders the model useless and unavailable to its end customer. If your AI system is implemented poorly and left unprotected, the attacker can overload the AI system with data inputs that cause it to exceed its computational and memory resources.

Detecting characteristics of an attack or attacker can be performed when attackers are gathering information on or have gathered information on our clients as targets.

There are many tools that attackers use to automate common tasks such as scanning the network and discovering services. Yet, most of the tasks that require creativity and human intelligence remain manual. For example, attackers can bypass the capture control presented on a web page. On the other hand, in another example, they can test and fine tune a malware code to make it fully undetectable. Such task cannot be automated by traditional programming. By applying Machine Learning, an attacker can bypass capture control, or even crack a password, or furthermore, utilize the data and API offered by a tool (e.g., VirusTotal), to test a fully undetectable malware.

In some examples, the system is configured to detect adversarial data and/or mutated inputs, adversarial reprogramming, and/or data poisoning attacks. For instance, the identity of an attacker behind a recent breach can be proved by investigating improper logging, distributed bots, proxy changes and/or other techniques. In the instance that AI is being employed in an attack, the AI provides another degree of separation between the attacker and the target. Thus, one or more tasks that an attacker would have to perform themselves can now be done by a ML model, which can run autonomously and make highly sophisticated decisions on behalf of the attacker (and take actions in response).

In the example of emerging IoT technologies and/or systems, these can be vulnerable to Sybil attacks, where attackers manipulate multiple fake identities to overwhelm and compromise the effectiveness of the systems' defenses. In the presence of Sybil attacks, the IoT systems may generate wrong reports, and users might receive spam and lose their privacy. To mitigate the impact from such an attack, the protected system can automatically and/or anonymously tag the fake identities (e.g., in a diversion environment). Once tagged, the fake identities can be tracked by the system. This allows the system to gain insight into the activities and specific targets of the attacker, and can, in some examples, gain access to the attacker's system or environment. Based on this information, the system can generate one or more responses, including preventing future access for the fake identity and/or other identities with similar characteristics, and/or planting malware for execution in the attacker's system, as a list of non-limiting examples.

In some examples, the system is configured to recreate a client environment by integrating the solution and testing the solution within the test client environment. This can be applied to one or more of the items to be protected, including device components, data, and/or software, as a list of non-limiting examples.

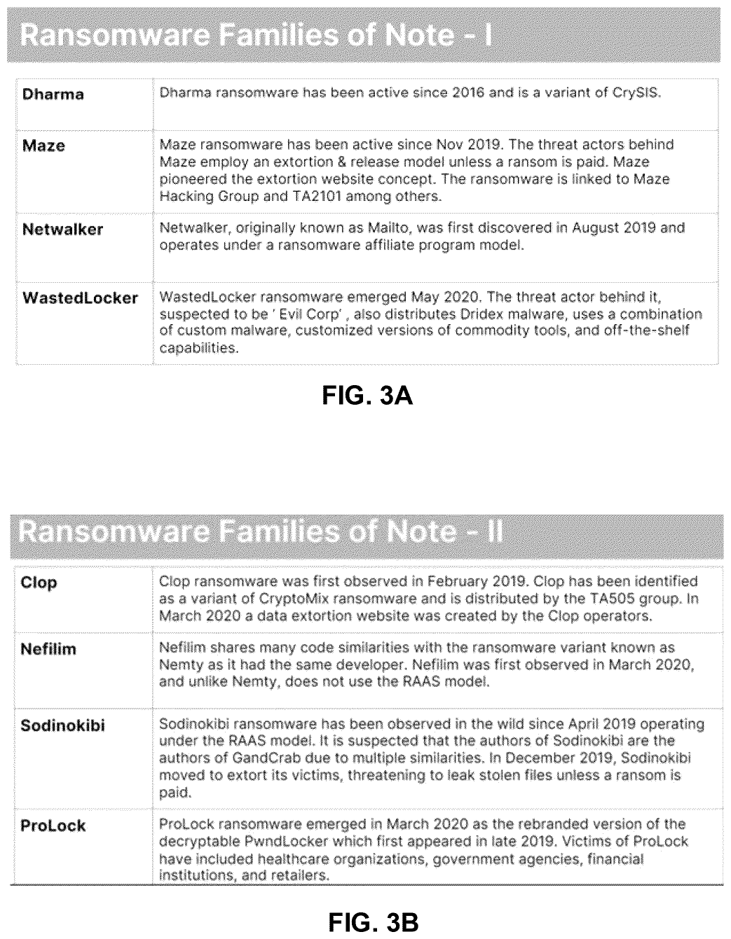

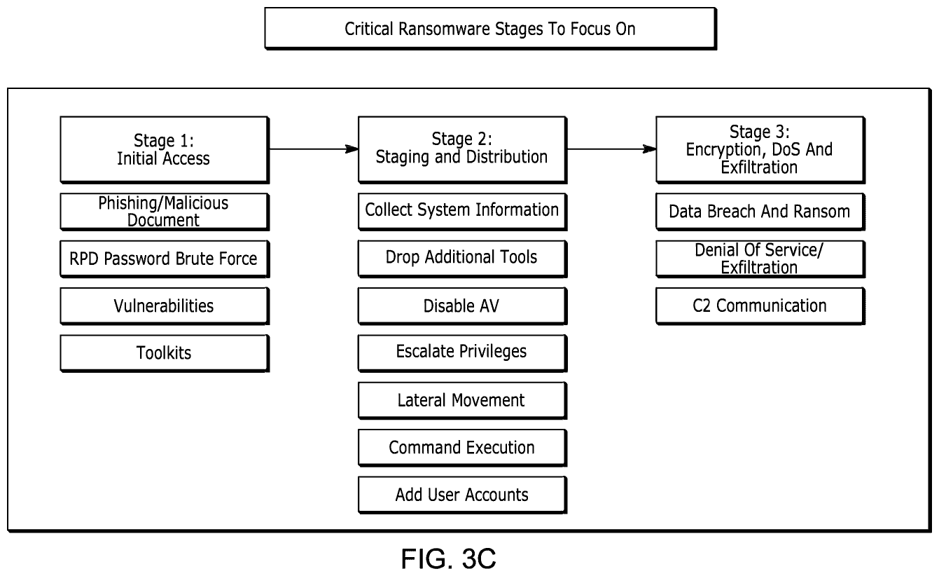

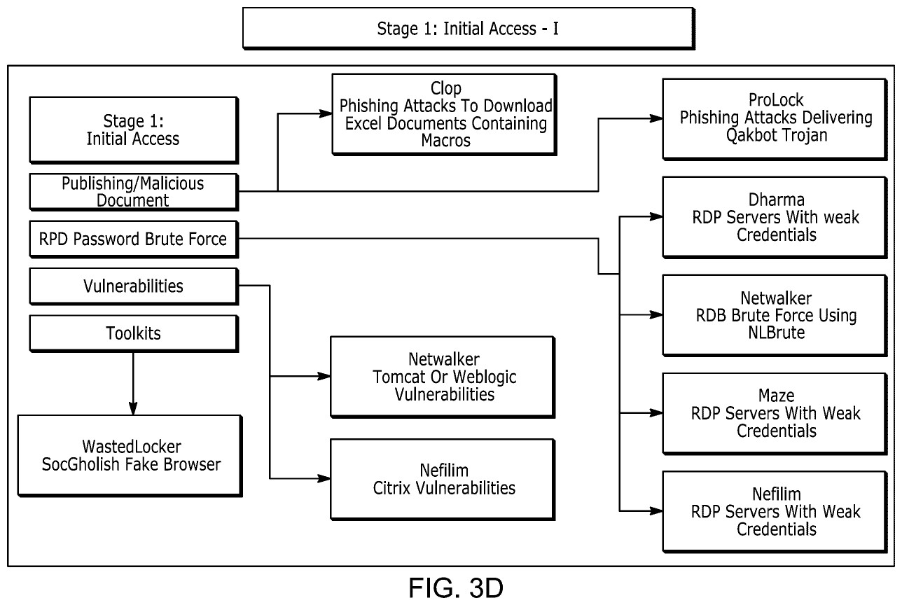

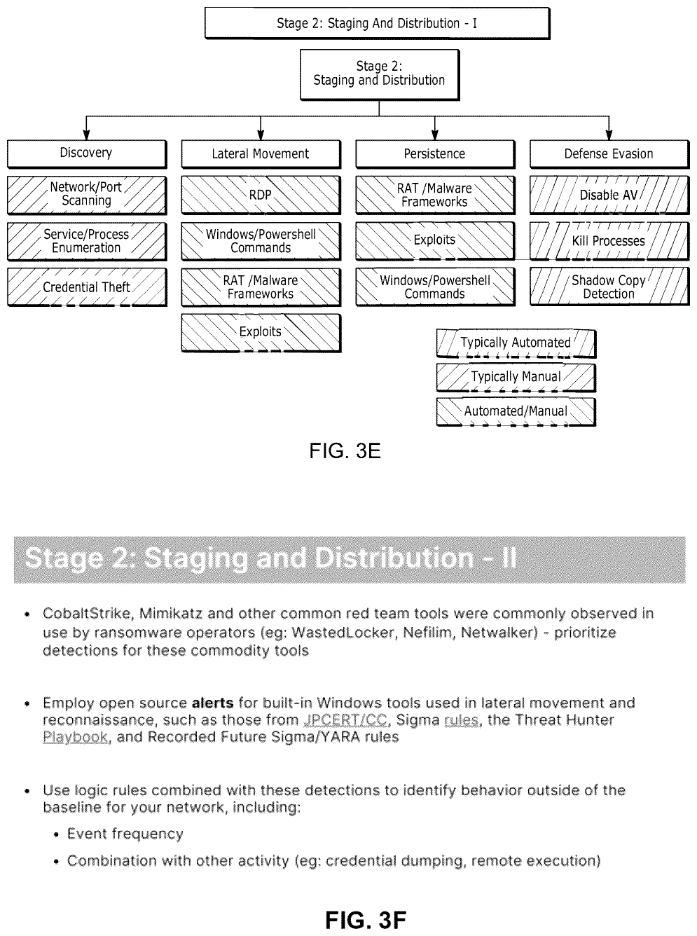

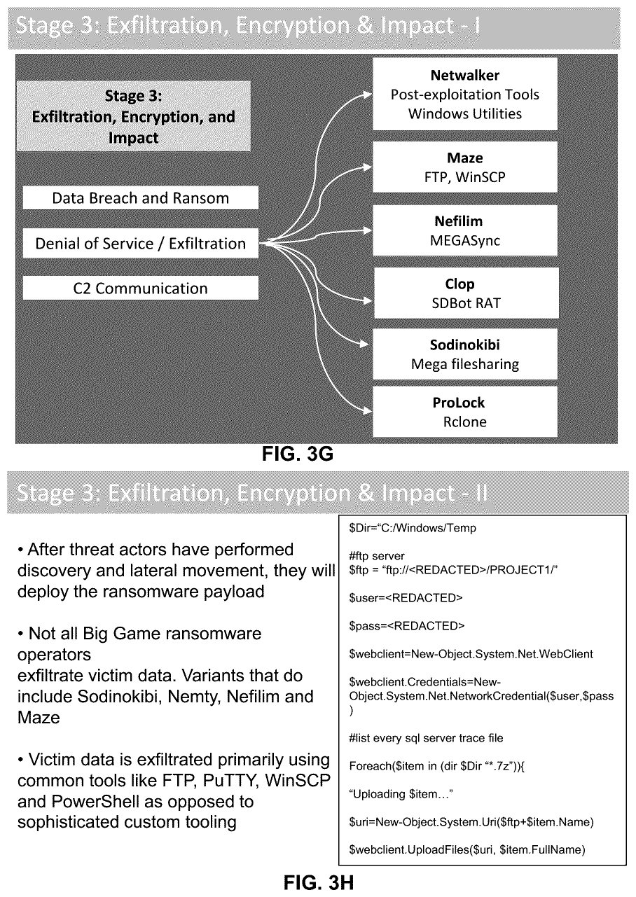

Examples of ransomware families can be found in FIGS. 3A and 3B. Critical ransomware stages for system administrator's focus are presented in FIG. 3C, described as Stage 1: Initial Access; Stage 2: Staging and Distribution; and Stage 3: Encryption, DoS, and Exfiltration.

Stage 1 reflects features of initial access for an attacker, shown in FIG. 3D. Stage 2 reflects features of Staging and Distribution for an attack, shown in FIGS. 3E and 3F. These include discovery (TA007), lateral movement (TA008), persistence (TA003), and defense evasion (TA005). Stage 3 reflects features of Exfiltration, Encryption, and Impact of an attack, shown in FIGS. 3G and 3H. These include impact (TA0040), exfiltration (TA0010), and network communication (TA0011).

In some examples, a data loss prevention (DLP) agent can be employed. The DLP agent can be configured to look for signs of confidential data crossing a trust boundary of the target organization. If the DLP agent suspects suspicious activity (e.g., based on crossing of confidential information or other activity), the system can block transmission of that data (and/or other data) and/or notify a system administrator.

Employing a DLP agent comes with a number of challenges. If DLP thresholds are set too high, the DLP agent may restrict even genuine messages or authorized traffic. To avoid impacting reasonable use of the target system and/or device, the administrator may make real-time threshold adjustments.

In particular, creation and/or employment of algorithms and/or agents within the security architecture must be able to operate independently of other algorithms and/or system protections, and should not degrade the integrity of any data. The system protections should make up a minimum amount of memory within the system, ideally with efficient, shorter keys (e.g., elliptic curve cryptography, etc.).

Moreover, each algorithm can be tested and/or broken within a test environment (e.g., a diversion environment) prior to being used within an active system.

The agent and/or algorithm can also be used to detect false entropy (e.g., an amount of randomness present in data). For example, if a “Q” is detected, more than likely it will be followed by a “U” due to how the English (and other) language is constructed. If such rules are violated, especially at scale, this may indicate evidence of an attack.

### Leveraging Quantum for Enhanced Security

Quantum technologies have the potential to provide an additional layer of digital security for a number of reasons. For instance, as the number of usable qubits increases in quantum machines, the speed with which quantum systems can analyze information increases exponentially compared to classical computers. Computations like data analytics and/or artificial intelligence, which require large parallel processing capabilities, can perform calculations in a matter of milliseconds, where classical computers may take ages to complete if at all.

In some examples, Non-Interactive Zero-Knowledge (NIZKs) proofs provide a powerful building block in the design of expressive cryptographic protocols such as anonymous credentials, anonymous survey systems, privacy-preserving digital currencies, and multi-party computation in general. In some examples, NIZKs are used to defend against malicious entities and/or actions, and/or to enforce honest behavior.

This technology can be used in conjunction with quantum functions and/or AI models to speed up defense against malicious activities to the point of proactivity. For example, the system can provide an offensive approach to protecting the data, systems and/or devices against an attack.

For example, these functions can speed up verification of honest behavior while also (often simultaneously) checking the related data for imposter tendencies. As an example, a malicious actor can disguise itself as an authorized user. To aid in identification of such actors, hashes can be assigned to authorized and/or existing users, data, and/or devices, which are authenticated by an authorized verification system employing one or more encryption processes. The hashes can include an encrypted key. and/or can be utilized with zero-knowledge, succinct non-interactive arguments of knowledge (zk-SNARK), such as a method of proving that something is true without revealing any other information. This method can be used for multi-factor authentication/verification and accessing data/devices, while leveraging quantum for speed. This enhances the auditing functionality of the system.

In some examples, the system leverages the sophistication of ML/DL to choose which algorithms or technologies to employ and when, based on the type of threat, data size, data classification, environments, person, and/or device identified. The most suitable encryption algorithms are often those best able to protect data and/or devices, while allowing for access and transmission of those data.

Protective systems should detect when large packet volumes of data are being sent to servers, sourced IP addresses, IoT devices, hijacks of Hadoop clusters, attacks against databases and applications (e.g., ISP/cloud providers), pulse waves, and/or outdated or poor security software installed on devices, as a list of non-limiting examples. Some of these attacks use bots, the use of which the system is configured to detect as disclosed herein. In some examples, pulse wave distributed denial of service (DDoS) is a new attack tactic designed by skilled bad actors to increase a botnet's output and target weak spots in device first/network second hybrid mitigation solutions.

For example, a DDoS attacks can look like many of the non-malicious activities that can cause availability issues—such as a downed server or system, too many legitimate requests from legitimate users, or even a cut cable. It often requires traffic analysis to determine what is precisely occurring. By employing the systems and algorithms disclosed herein, the protection system can identify characteristics of the actions and/or actor and determine whether they have authorization to navigate the system and/or access data therein.

Masslogger is a spyware program written in .NET with a focus on stealing user credentials, mostly from the browsers but also from several popular messaging applications and email clients (e.g., Edge overload attacks). It was released in April 2020 and sold on underground forums for a moderate price with a few licensing options.

The exfiltration of data takes place over one or more of these channels: ⋅FTP (plain text over default port 21), the configuration contains user credentials. HTTP—Using a PHP-based control panel. SMTP—The user has to specify the email address, server and credentials to use it.

There are several examples. Lazarus is a North Korean hacking group that has been active since 2009. The group has primarily been linked with ransomware campaigns, cyberespionage, and attacks against the cryptocurrency market. ThreatNeedle is installed upon the document being opened, and this allows the attacker to take control of the infected machine. The main goal of the backdoor is to extract confidential information and send it to the attackers by moving laterally through the infected networks. Spearphishing is the method commonly used to deliver ThreatNeedle to the targets. The malicious Word documents are written to sound like urgent communication and updates regarding COVID-19.

In order to prevent fraudsters (aka synthetic identities) from gaining access to an unregistered account (e.g., preventing the setting of original data points, such as a phone number or other piece of information), the protective system can apply the methods described herein to identify characteristics of an attack to conclude the activity is suspicious.

In some examples, a relationship between actors can be revealed. For instance, as some of these malicious actors are part of a common organization, a process referred to as ‘cash-cycling’ may occur. This may include money being circulated between fraudulent accounts to imitate legitimate financial activity. As a result, traditional security measures will likely consider these accounts to be completely genuine.

The disclosed protective systems employs user behavior analysis with biometric authentication. For instance, the system collects multiple (e.g., thousands or more) key parameters on how the investigated user(s) navigate through a banking portal and fill out a new account form. These parameters provide essential information on whether the user has abnormal fluidity and/or familiarity that raises suspicions that they are not a genuine customer. As disclosed, this monitoring and analysis occurs in the background without impacting the user experience.

In some examples, the parameters being monitored and analyzed include the fluency pattern (e.g., how easily they navigate around the bank application); context knowledge latency (e.g., familiarity with the onboarding application); brain response (e.g., short- and long-term memory responses to fill out specific data—such as long-term memory is used by legitimate customers to fill out details like names and addresses, but short-term memory may be needed for more complex info like ID card numbers); customer type pattern comparison (e.g., compares new user behavior patterns with other applicants in the same bank as well with the modus operandi of the bank's fraudsters).

To develop robust operations technology (OT) cyber security roadmaps and foundations, organizations with OT systems (e.g., from manufacturing process controls to building control systems to security access systems) should embrace the concept of Operations Technology System Management (OTSM), paralleling their ITSM practices, but within the unique environments of operating systems. Achieving a mature level of OTSM is critical to improve overall ROI from increasingly connected industrial systems and to ensure foundational elements of OT cyber security are in place to protect critical infrastructure from targeted and untargeted attacks.

Employing disclosed methods and systems to gain insight into all hardware and software in the network ensures vulnerabilities are identified quickly. This includes properly updated and configured systems to reduce opportunities for cyber-attacks; operationally-efficient systems update to provide automation on key operational tasks; consistent reporting and monitoring across IT and OT for simplified progress documentation; effective advanced security controls built with proper visibility and access to the underlying endpoints and network data.

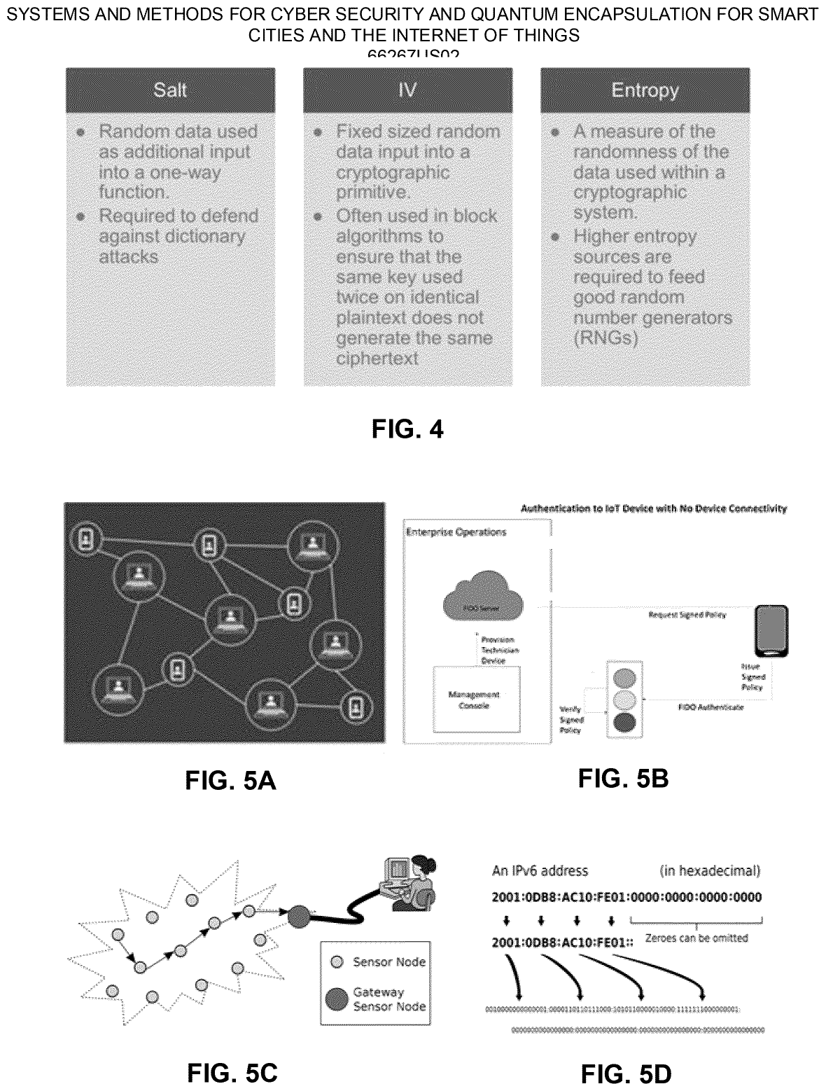

The challenges in secure password storage should also be addressed. Entities struggle with password storage in a variety of different ways, such as storing credentials in plaintext (Facebook); use of an insecure hash function (MyHeritage); and/or improperly salting passwords (MyFitnessPal) see, e.g., FIG. 4. For instance, misuse of salting, use of no hash function, or using the wrong hash function. Secure credential storage is needed to verify passwords the end user enters with what is stored.

In some examples, hash functions protect data integrity. For instance, hash functions have useful properties for data integrity protection (e.g., via one-way functions and/or collision resistance. They are commonly used for this purpose. Further, providing a hash alongside data makes it easier to detect tampering or other issues

In some examples, applications of multiparty computation are used to secure multiparty computation can be applied whenever an individual's private data should be kept secret (e.g., elections, corporate partnerships, processing of personal data, etc.).

A pass the hash attack is an exploit in which an attacker steals a hashed user credential and—without cracking it—reuses it to trick an authentication system into creating a new authenticated session on the same network. Pass the hash is primarily a lateral movement technique. This means that hackers are using pass the hash to extract additional information and credentials after already compromising a device. By laterally moving between devices and accounts, attackers can use pass the hash to gain the right credentials to eventually escalate their domain privileges and access more influential systems, such as an administrator account on the domain controller. Most of the movement executed during a pass the hash attack uses a remote software program, such as malware.

To mitigate the threat of a pass the hash attack, organizations should ensure domain controllers can only be accessed from trusted systems without internet access. Two-factor authentication that uses tokens should also be enforced, as well as the principle of least privilege. Organizations should closely monitor hosts and traffic within their networks for suspect activity.

There are several types of Post-Quantum Cryptography being considered for security purposes. These include Lattice-based, Multivariate, Hash-based, Code-based, and Supersingular elliptic curve isogeny, as a non-limiting list of examples. Grover's algorithm, for instance, reduces the security of symmetric encryption systems, and can therefore be used to lure hackers/malicious actors into a diversion environment, as provided herein.

Applications of Post-Quantum Cryptography can be useful for systems with long lifetimes, such as SSL/TLS, Blockchain technologies, and/or embedded systems, as a list of non-limiting examples. Disclosed systems implement post quantum cryptography to protect the blockchain information being targeted and/or changed by hackers. The use of quantum keys to outrun the quantum computer make it harder for the quantum computer to solve the algorithm. In this example, more qubits will make a system more secure.

In some examples, the system encrypts data via homomorphic encryption. Fully homomorphic systems allow an unlimited number of additions and multiplications. Partially homomorphic systems allow certain numbers and types of operations. Multiple different generations of fully homomorphic encryption algorithms exist. Some examples are based on post-quantum cryptographic algorithms (lattice-based cryptography); often using bootstrapping to convert partially-homomorphic systems to FHE. Applications of Homomorphic Encryption can be useful for applications where processing of encrypted data is useful, such as untrusted platforms and/or Sharing of sensitive data.

Quantum error correction (QEC) is used in quantum computing to protect quantum information from errors due to decoherence and other quantum noise. It is possible to spread the information of one qubit onto a highly entangled state of several (physical) qubits.

Quantum error correction is a set of methods to protect quantum information—that is, quantum states—from unwanted environmental interactions (decoherence) and other forms of noise. The information is stored in a quantum error-correcting code, which is a subspace in a larger Hilbert space. This code is designed so that the most common errors move the state into an error space orthogonal to the original code space while preserving the information in the state. It is possible to determine whether an error has occurred by a suitable measurement and to apply a unitary correction that returns the state to the code space, without measuring (and hence disturbing) the protected state itself. In general, codewords of a quantum code are entangled states. No code that stores information can protect against all possible errors; instead, codes are designed to correct a specific error set, which should be chosen to match the most likely types of noise. An error set is represented by a set of operators that can multiply the codeword state. Quantum error correction is used to protect information in quantum communication (where quantum states pass through noisy channels) and quantum computation (where quantum states are transformed through a sequence of imperfect computational steps in the presence of environmental decoherence to solve a computational problem). In quantum computation, error correction is just one component of fault-tolerant design.

The system will employ security parameters such as Lamport signatures (e.g., for Department of Defense (DoD) related systems, such as employing wireless protocols) with biometric authentication/verification to send and receive messages. There may exist ways to circumvent such systems, such as using flak, or generating false photon streams. For instance, if a pilot in a war plane responds to radar signals by trying to send back a false pattern, the pilot (e.g., the equipment) would have to know what the original signal looked like, which means they would have to be observed—a form of measurement. Doing so could cause the signals to be changed. Because of that possibility, the photon (e.g., signal) stream that is sent back in reply would be obvious to the recipient because it would no longer match the properties of the stream that was originally sent.

The protective system uses biometric verification and authentication (as well as GPS, blockchain access, etc.) to send and receive one or more signals. This adds a layer of detecting interception and deceptive attacks. In some examples, this can be performed machine-to-machine (e.g., via one or more nodes, such as 5G cell towers, and within networked Industrial environments). In some examples, changing which quantum secure system being used given the known conditions of possible interference or attack, while using a highly secure quantum system, allows for added protection. This can include modulation of the quantum states, and/or housing devices/data in blockchain with an access list of people, data, systems and/or other devices with which the system can communicate.

The security of Lamport signatures is based on security of the one way hash function, the length of its output and the quality of the input.

For a hash function that generates an n-bit message digest, the ideal preimage and 2nd preimage resistance on a single hash function invocation implies on the order of 2n operations and 2n bits of memory effort to find a collision under a classical computing model. According to Grover's algorithm, finding a preimage collision on a single invocation of an ideal hash function is upper bound on 0(2n/2) operations under a quantum computing model. In Lamport signatures, each bit of the public key and signature is based on short messages requiring only a single invocation to a hash function.

For each private key yi,j and its corresponding zi,j public key pair, the private key length must be selected so performing a preimage attack on the length of the input is not faster than performing a preimage attack on the length of the output. For example, in a degenerate case, if each private key yi,j element was only 16 bits in length, it is trivial to exhaustively search all 216 possible private key combinations in 215 operations to find a match with the output, irrespective of the message digest length. Therefore, a balanced system design ensures both lengths are approximately equal.

Based on Grover's algorithm used in a quantum secure system, the length of the public key elements (zi,j), the private key elements (yi,j) and the signature elements (si,j) must be no less than two times larger than the security rating of the system. That is: an 80-bit secure system uses element lengths of no less than 160 bit; an 128-bit secure systems uses element lengths of no less than 256 bit; etc.

However caution should be taken as the idealistic work estimates above assume an ideal (perfect) hash function and are limited to attacks that target only a single preimage at a time. It is known under a conventional computing model that if 23n/5 preimages are searched, the full cost per preimage decreases from 2n/2 to 22n/5. Selecting the optimum element size taking into account the collection of multiple message digests is an open problem. Selection of larger element sizes and stronger hash functions, such as 512-bit elements and SHA-512, ensures greater security margins to manage these unknowns.

With reference to FIGS. 5A to 5D, leveraging blockchain provides certain advantages for a security system. For instance, a Smart Contract is computer code that lives on the blockchain to help exchange anything of value in a transparent, conflict-free way, while avoiding the services of a middleman or intermediary. The code provides the rules, penalties and conditions of the contract. The contract carries out its logic automatically. Once specific conditions are met, the contract carries them out automatically. Smart contracts are used to enable secure communications or to restrict security transactions.

Blockchain can be used to record transactions. Transactions can be of any sort—for example, a transaction could be associated with Identity management operations, Log files, Software distribution operations, etc., and/or Smart Contracts can be used to enforce security controls.

Blockchain can also be employed for trusted IoT communications. For instance, implementing blockchain technology to store and manage cryptographic credentials for IoT devices can store public keys on a ledger, and/or store all key or certificate operations on the chain.

Reputation-based scoring of each key or certificate can be stored on the chain, as well as a misbehavior detection layer and risk adaptive controls to keys and certificates. For example, the reputation of a particular device could be degraded if many peers report issues—meaning that even though a valid certificate for that device exists, the trust in that certificate might be reduced

Blockchain can also be employed for Semi-Autonomous machine-to-machine (or system-to-system, or network to network) transactions. For example, a critical enabler of IoT technology is the ability for machines to work together in a semi-autonomous fashion towards achievement of a specific goal. Blockchain can act as a security-enabler of these autonomous transactions using smart contract functionality. Edge IoT devices can then be configured with an API to interact with the smart contract to enter into agreements with peer devices and/or services.

Blockchain also enables IoT Configuration and Update Controls. For example, the ledger can host IoT properties (For example, the last version of validated firmware and configuration details. During bootstrap, the IoT device asks the transaction node to get its configuration from the ledger or the ledger can host the hash value of the latest configuration file for each IoT device.

Blockchain also enables Secure Firmware Distribution. For example, blockchain can enable secure firmware updates. For example, vendors can write the hash of a firmware file to the blockchain, and devices can validate that hash upon securely loading the firmware.

In some examples, biometric authentication can be required to access an IoT Device. For example, to support authentication to an IoT device with no backend connectivity. A technician downloads a signed policy file from back office FIDO server, and performs a FIDO authentication over local protocol (NFC/Bluetooth) to the IoT device that validates the signed policy. The signed policy authorizes the technician to authenticate to the IoT device using a specified biometric (e.g., a fingerprint, retinal scan, voice recognition, etc.). In some examples, authentication to an IoT Device can be performed without device connectivity.

A FIDO server can be used to signed challenges issued to an IoT device. An administrator uses a mobile device with biometric capabilities as a conduit through which the administrator can authenticate to an IoT device using their biometrics. The IoT Device can act as a proxy to a FIDO server when connectivity to the FIDO server is available; otherwise the device acts as a cryptographic verification agent to validate the signed policy file provided by the administrator during authentication

In some examples, the system can draft a Security CONOPS Document or protocol. This can include documenting the various approaches to security. The document can incorporate authentication and access control capabilities for device management. It can identify monitoring and compliance approaches, define misuse cases for the systems, and/or explain how to integrate IoT monitoring with existing SIEM systems.

The document can define unique approaches to forensics, identifying best practices, mapping business functions to the IoT systems, understanding the impact if a system is taken offline, and document emergency POCs for each system. Such protocols can be integrated into existing security systems. For instance, IoT systems can often make use of existing enterprise security systems, which include directory systems. Remote access to these devices can be locked, and consider common or unique misuse cases associated with the IoT device, and proactively mitigate such uses.

By integrating these protocols into existing security systems, an entity can manage all of the many of IoT devices in their inventory, while using existing asset management systems, and maintaining management of the approved configurations for each device.

When integrating such protocols into existing security systems, the following should be considered: Do your systems ride on the same network as the rest; Ports and protocols required to be open through boundary defenses; Managing keys for your IoT devices; Wireless access control capabilities; Use Wi-Fi for communications; Integration with your existing wireless access control systems.

When adopting a New Security System, impact from the following should be considered: Wireless sensor networks that run on Zigbee; Introduction to gateways; Provide security for the IoT devices.

When evaluating a new security systems, the following should be considered: the use of IPv6; Updates your data center architectures; Placement of analytics systems; Re-examine your security architecture to protect the assets that were previously sequestered in the cloud or elsewhere.

Updates to user security training may include security awareness training for users, such as: The risks associated with IoT devices; Policies related to bringing personal IoT devices into the organization; Privacy protection requirements related to data collected by IoT devices; Procedures for interfacing (if allowable) with corporate IoT devices. Updates to the Administrator Security Training should include: Policies for allowable IoT use within an organization; Detailed technology overview of the new IoT assets and sensitive data supported by the new IoT systems; Procedures for bringing a new IoT device online; Procedures to monitor the security posture of IoT devices; Procedures to update your incident response plans.

Security awareness training for users should include consideration of: The risks associated with IoT devices; Policies related to bringing personal IoT devices into the organization; Privacy protection requirements related to data collected by IoT devices; Procedures for interfacing (if allowable) with corporate IoT devices.

In some examples, information pulled from user behavior analysis can be used to guide or supplement cyber security awareness training for authorized users.

In some examples, the system can supplement and/or replace Cyber Workforce via SaaS implementation. For example, secure configurations can include securely configuring devices to restrict loading of unauthenticated data such as firmware; denying unauthorized ports and protocols; accepting trusted connections through whitelisting; and/or pairing methods allowed by connection devices (e.g., Bluetooth enabled devices, etc.).

Updates to administrator security training can also include determining and implementing policies for allowable IoT use within an organization; detailed technology overview of the new IoT assets and sensitive data supported by the new IoT systems; procedures for bringing a new IoT device online; procedures to monitor the security posture of IoT devices; and/or procedures to update your incident response plans.

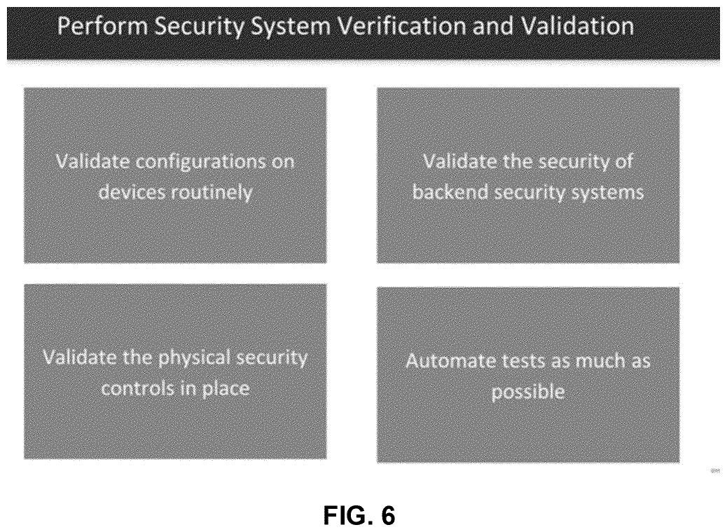

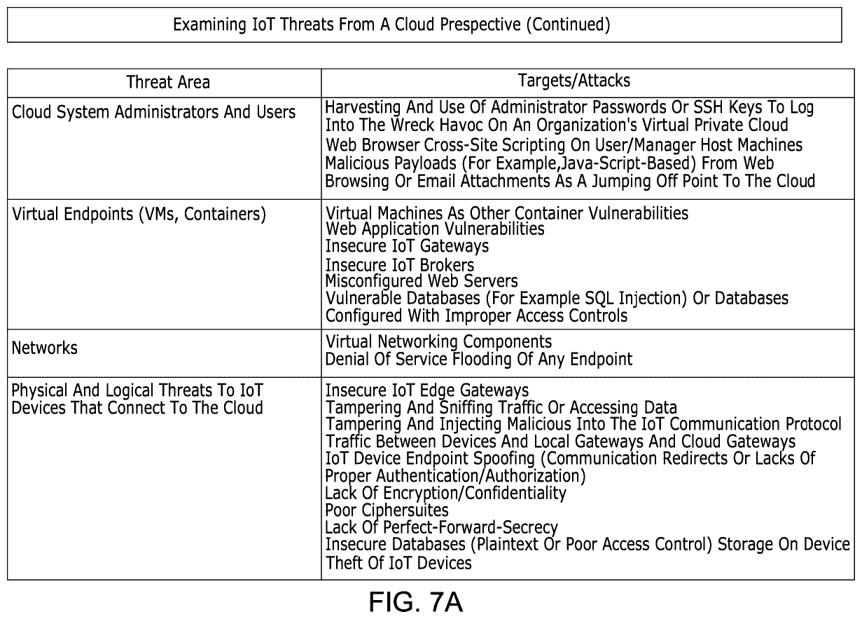

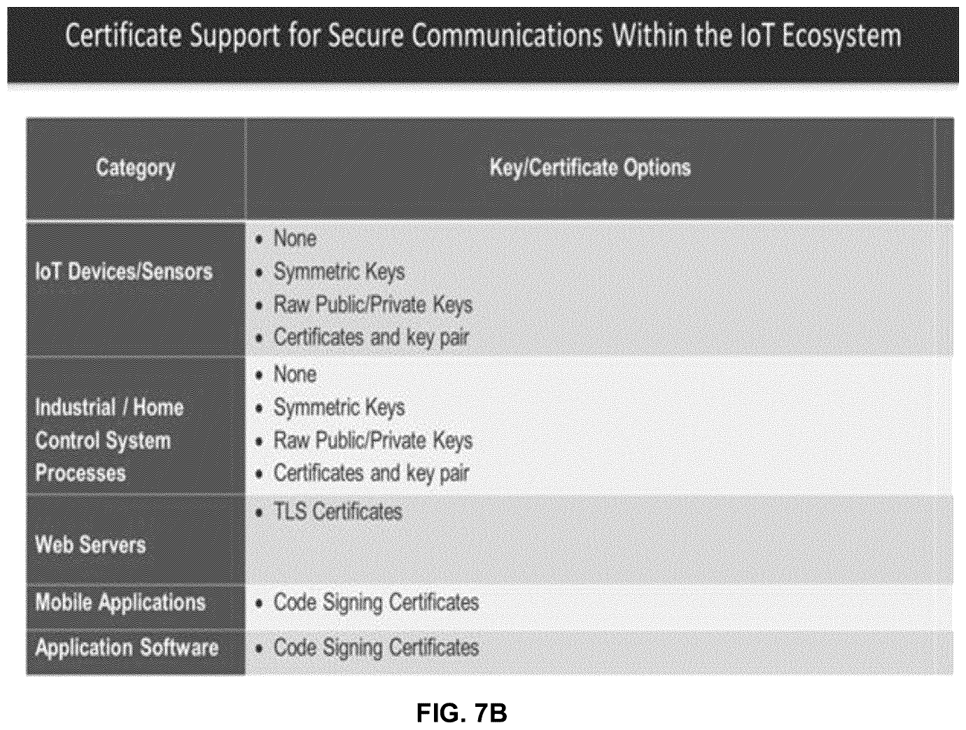

New Models for IoT Collaboration can be implemented, for instance, with use of a network or cloud based solution, with reference to FIG. 6. Security engineers have to be prepared to help IoT system architects looking for device new connectivity and collaboration layers. Layers span an entire organization, an industry, or even cross industry boundaries. Edge devices communicate with the cloud using web sockets, RESTful web services, or MQTT. Protocols are supported also via custom APIs or by tunneling them through a gateway. Data coming in to the cloud may be in batches or it may be a continuous stream. CSPs often have different interfaces (AWS Kinesis for the capture of the different types of data from the edge). Data, e.g., messaging, video, imagery. Services support processing based on events, messaging, search, notifications. Some example computing services allow the user to specify actions to take on some types of data or behaviors. There are more advanced services such as machine learning, voice processing, and other data analytics. Examination of IoT threats, such as from a cloud perspective, are explained with reference to FIG. 7A.

In some examples, the system can employ certificates to help secure the IoT devices and systems, as disclosed with reference to FIG. 7B. For example, the IoT devices/protocols often provide choices with respect to credentials (e.g., Pre-shared Symmetric keys, Key pairs, certificates). Many of the IoT protocols provide built-in certificate-based device-to-device authentication, such as: CoAP, DDS; Other protocols such as MQTT (and HTTP) rely on TLS as an underlying security mechanism; TLS supports two-way certificate-based authentication (IoT device/service).

For evaluation of the Safety Impacts on Systems in view of the intended usage of the product, it is helpful to consider whether there is anything harmful that could occur if the product stopped working as intended or stopped working completely. For instance, a vehicle, drone a commercial airliner, large autonomous ship, pacemaker, or pumps. Also, if there are any safety-critical services or other products that rely upon the functioning of this product. Safeguards, such as redundancies, can mitigate or prevent potential harm (e.g., from device failure). This is useful for safety-critical devices, to prevent an attacker from disabling built-in safety features.

The results of a safety impact assessment will provide a view into the malfunctions and misbehaviors that could result from a device compromise. The outputs from the Safety Impact Assessment can be feed into the system's larger risk management strategy

To ensure IoT Systems are secured, one or more processes and/or agreements should be identified and implemented. For example, processes should be established across the enterprise to maintain a secure posture within IoT systems. This should include establishing Governance Functions, Policy Management Frameworks, and/or Configuration Control Board (CCB). In some examples, establishing and enforcing agreements with third party organizations can be useful, including Service Level Agreements (SLA), Privacy Agreements/Data Sharing, and/or Information Sharing (e.g., threat intelligence).

Governance standards should be established for the IoT systems. This can include identifying who is accountable for the safe and secure operation of the IoT system (e.g., a senior executive of the organization), what budgets should be evaluated ensure adequate availability of cyber security controls, establishing governance principles that flow down to all IoT systems, with a focus on privacy protection and defense against threats (both physical and cyber).

A useful policy management framework includes analysis of regulations related to your industry or market, which flow down into requirements for IoT systems; privacy requirements; incident reporting requirements; security testing requirements; compliance requirements; establishment of a Configuration Control Board (CCB); review and assessment of proposed configuration changes; directing updates to configurations, based on modified or new regulations; establishing touchpoints to review required configurations on a regular (e.g., annual) basis; establishing and enforcing agreements with third party organizations (e.g., data sharing agreements—what data can be shared? what processes must be put in place to protect data privacy? when must data be destroyed? can data be onward transferred?).

Example agreements with third party organizations can cover elements of cloud integration, availability (SLAs), security mechanisms (e.g., reporting requirements—event types, timeliness of reporting), incident management support (e.g., what support is required during an incident), IoT product acquisitions, and/or patch updates (e.g., type, schedule, access, etc.).

In some examples, the system can perform a Safety Impact Assessment by employing the systems' predictive analytics and ML models. For example, the system can detect recorded video to decrease the vulnerability in continuous authentication/verification processes. The is added to other user behavioral analysis functions, where the system compares baseline behaviors to real-time behavior.

As disclosed herein, updates can be executed/tested in a separate, independently controlled testing environment (e.g., a diversion environment) before sending to clients as updates. This includes code, patches, data, and/or algorithms (e.g., to avoid a Solarwind-type breach). This includes testing and/or observation of third party patches, data, and/or updates.

The system can further defend against so-called typosquat—attacks. Also known as a URL hijacking, a sting site, or a fake URL, typosquat is a type of social engineering where malicious actors impersonate legitimate domains for malicious purposes, such as fraud or malware spreading. This can be implemented by the detection and prevention methods disclosed herein, including identification of attacker characteristics and/or blocking access to requests that bear such characteristics.

The protection system is applicable to hardware systems to ensure each connected and/or accessed device is an authorized device (or “trusted platform”) as illustrated in FIG. 8A.

The system can be employed for Ransomware as a Service (RaaS) detection. In some disclosed examples, an AI agent can be sent to one or more environments (e.g., the dark web) to extract information about potential attacks. For instance, the AI agent can pose as a buyer of malicious code, take the explicit code back to a test environment and figure out how to detonate, corrupt, and/or terminate the code completely so it can never be used. In some examples, this is enacted by creating code to terminate the code, or other research means, which may include identifying the characteristics of the malicious code to enhance detection and/or mitigation efforts.

An example of a vulnerability on a domain name system (DNS) implementation is DNSpooq. This can manifest as a set of seven critical Common Vulnerabilities and Exposures (CVEs) affecting the DNS forwarder dnsmasq, which is used by major networking vendors to cache the results of DNS requests.

Vulnerabilities in DNS implementations are related to a protocol feature called “message compression.” Since DNS response packets often include the same domain name or a part of it several times, RFC 1035 (“Domain Names—Implementation and Specification”) specifies a compression mechanism to reduce the size of DNS messages in its section 4.1.4 (“Message compression”). This type of encoding is used not only in DNS resolvers but also in multicast DNS (mDNS), DHCP clients as specified in RFC 3397 (“Dynamic Host Configuration Protocol (DHCP) Domain Search Option”) and IPv6 router advertisements as specified in RFC8106 (“IPv6 Router Advertisement Options for DNS Configuration”). Also, while some protocols do not officially support compression, many implementations still do support it because of code reuse or a specific understanding of the specifications.

If an attacker crafts a DNS response packet with a combination of invalid compression pointer offsets that allows them to write arbitrary data into sensitive parts of a device's memory, they could be enabled to inject the code with data. The second vulnerability, CVE2020-15795, allows the attacker to construct meaningful code to be injected by abusing very large domain name records in the malicious packet. Finally, to deliver the malicious packet to the target, the attacker can bypass DNS query-response matching using CVE-2021-25667.

A suitable response can be implemented by the detection and prevention methods disclosed herein, including identification of attacker characteristics and/or blocking access to requests that bear such characteristics.

Some example implementations leverage quantum to break down the data, as illustrated in the example of FIG. 8B.

### TOTAL IoT SECURITY FROM SILICON TO CLOUD.

World-leading Ai, Blockchain, and quantum driven cybersecurity that future-proofs your IoT ecosystem.

### Infiltron Software Suite™

Security is not an OR function—it's an AND function. You need hardware and software in the supply chain or your security system will fail.
That's why Infiltron brings the fastest, easiest path to scalable IoT deployment with the most comprehensive, secure approach. Infiltron comprises hardware and software innovations, that can integrate with your IoT network.

### Infiltron Quantum Encapsulation™

The world's first IoT blockchain quantum trust solution design capable of integrating security protection with legacy systems, smart systems, sim cards, and FPGA for software and hardware root of trust. IQEI delivers on-demand, high-entropy, unforgeable cryptographic keys from silicon for unique identification of IoT devices and users.

### Infiltron Software Suite™

Our zero-touch, zero-trust universal IoT security platform handles all-in-one provisioning, automated secure onboarding and continuous proactive protection of your users, devices, and data.

### Market Advantages of Infiltron's Suite

The Infiltron Suite delivers four functional advantages to provide the highest standard of security and realize your IoT's potential.
Zero-touch assurance—Delivering full automation for the assignment of unique identities, certification management, device provisioning and management, firmware updates and de-provisioning. No manual steps required.
Ready-to-go security—A fast, practical road to security, whether starting with hardware, software or both. Accelerate your time to market with easy, impenetrable protection.
Extensible security—Infiltron works with any root of trust, device type and identity scheme for easy and effective integration. Migration of hardware to IQEI is possible for a flexible approach to security.
Total security—Futureproof, unforgeable end-to-end security from silicon to cloud.

### Notes:

Expedite threat research and improve reporting with unprecedented security intelligence.
Detect and validate incidents with context.
Hunt for threats in your environment
Monitor and investigate the dark web for risks to your organization.
Access all known information in a single, real-time view and via customized alerts.
Protect your business with continuous fraud detection and brand monitoring.

### Infiltron Software Suite

Our zero-touch, zero-trust universal IoT security platform handles all-in-one provisioning, automated secure onboarding and continuous proactive protection of your users, devices, and data.
Infiltron's blockchain biometric authentication/verification with quantum encapsulation for devices, users, and data.
Infiltron's predictive analytics and machine learning tools assess systems, give offensive protection from external/internal attacks [ex. Patching & social engineering] and support recovery time after a data breach.
Infiltron provides the critical visibility to ensure continuous compliance and enforcement to mitigate and manage risks for increase of IoT devices.
Analyzing user behavior for compliance to provide data analytics to give the business to solve problems facing the organization, for example, cutting cost, innovations to improve system protection and efficiency proofing other processes.
Infiltron creates real-time cybersecurity training modules for individuals and organizations per device, system, and location.
   Each of our offerings can be implemented together or separate, except our cybersecurity training must include our behavior analytics to provide accurate insights to decrease insider threat and better equip clients' users on different cyber attacks they may face daily.

### Infiltron Assessments & Auditing

The first step of Infiltron's assessment and auditing is the gathering of information. In this step, Infiltron finds out the intricacies of a system such as CMS version, Server OS, assets, number of end users, etc. This stage also involves defining the scope and requirements that leads to proper implementation of Infiltron products.
Biometric Bias Audit//link to Biometric accountability
Cloud Audit
Container Audit
IoT Audit
Software/API Audit
   After the assessment and audit is performed Infiltron provides analysis of the results found, compiling them in a detailed manner including:
The loopholes and vulnerabilities exposed during the testing.
The threats these vulnerabilities possess against the system.
Sensitive data assessed during the testing.
The level up to which the audit was able to exploit these vulnerabilities while remaining undetected.

### Infiltron Quantum Encapsulation Integration (IQEI)

### What is IQEI?

At the core of device security is the root of trust and the ability to identify who is accessing a system, —a unique identity that identifies a system when deployed, and that cannot be counterfeited, hacked, or breached.
IQEI stands for Infiltron Quantum Encapsulation Integration. Each IEQI FPGA or sim card measures and authenticates at quantum-level forms the basis of unique device identity and unbeatable security.
Other hardware and physical unclonable functions (PUFs) can't offer full security. Electronic devices are vulnerable to hacks, side-channel attacks, and counterfeiting. Chips are resource-intensive to fabricate and manufacture (silicon space, energy, tests, costs) and still penetrable. They require secret key injection for authentication, which is risky, costly, complex and error prone.
But a unique, silicon-based identity can secure billions of IoT devices without these risks. By harnessing quantum effects to create unforgeable identities and originate independent, tamper-proof cryptographic keys on demand, IQEI is by far the safest model of chip security.
What's more, IQIE connects with Infiltron Software Suite for unbeatable end-to-end security. Quantum techniques will soon render alternate PUFs obsolete.

### Why Use IQIE?

Other PUFs and hardware security devices are penetrable. Ours is uncrackable. IQIE's benefits provide fast scale and end-to-end security:
Genuine randomness—High-entropy quantum effects make number generation unpredictable and identity truly unique.
Generates multiple keys—Easily authenticate devices with different personas or change the function of existing keys (repurposing devices or changing ownership).
Plug-and-play—Easy integration in standard CMOS.
Zero-touch—No secret key injection or secure storage needed.
Tamper-proof—Due to unique atomic structure, quantum processes and high-quality industry circuitry, sabotage is no longer a threat.
Cost-effective—Improves ROI, lowering overhead and accelerating scale.
End-to-end security—Unique identity provides key management that secures every touchpoint of your IoT network.

### IQEI Passes Intensive Industry-Standard Tests

IQEI has proven to be impervious to glitches, temperature attacks, array aging, remanence decay and tampering. IQEI has passed rigorous tests over voltage, temperature, and process nodes in accordance with the National Institute of Science and Technology (NIST).

### Industries

### Critical Infrastructure/Industrial

Manufacturing is the biggest investment for IoT. Sensors, devices, instruments and a suite of technologies rely on a stable IoT network to drive further innovation. Smart manufacturing now relies less on closed networks and more on cloud-based solutions for remote management. End-to-end security helps supply chains and innovators safely communicate and share information that brings breakthroughs to the industrial sector.

### Communications and Networks

Industries that relay sensitive information and handle unfathomable amounts of private data are at the mercy of hackers. The bigger and more complex the network, the more likely a weak link in the security chain can emerge. End-to-end security is imperative to removing the opportunity for cyberattacks to wreak havoc over data and network connections. With our approach, not even a quantum computer can break in.

### Healthcare

Frequent cyber-attacks on public health systems and vaccine centers during the Covid era prove the urgency for unbeatable cybersecurity. Healthcare needs the highest end-to-end security and scalability possible to protect sensitive medical data shared with professionals and accelerate the progress of medical science to deliver the highest standard of care to those who need it fast.

### Governments

Security has been the top concern around IoT from the start because it monitors and manages sensitive applications—from a city's water supply to a family's home security system. While the government may not directly purchase consumer-based IoT devices, government employees do, and with pandemic-induced telework, all bets are off as to what vulnerable devices may be connected via a government worker's laptop or home network. In addition, the defense contractors may have vulnerable IoT devices in their networks, providing a back door into the networks and demanding just as much security as government devices.

### ABMS

Software that tells the vulnerabilities in a network and adversaries logic maps. It assesses the risk in real-time with objective fused information powered by a protected AI/ML data stream pulling in from multiple cloud repositories.
Edge node speed.
How do you increase security of the waveforms without slowing it down by adding more encryption devices?
How do I Connect to 5G securely from a fast moving aircraft?
How do we drop server farms into Polaris razor's and have a moving fighting server farm for edge data?
smart cities, autonomous vehicles, buildings,
sensors (wearable devices, battlefield components/vehicles)

### Company

Infiltron is a deep technology company that has developed a transformational cybersecurity technology, using the most advanced techniques in cybersecurity and quantum, designed to ensure that device user, and data security becomes foundational and end-to-end IoT security becomes standard practice.
Infiltron's ground-breaking technology radically simplifies the process of generating a root of trust in an IoT devices and users, solving the issue of secure onboarding an IoT devices and users in an untrusted environment and plugs the gaping device security hole that currently exists in the IoT ecosystem.

### Research and Product Development

Securing the IoT is a complex and multi-dimensional challenge. The threat landscape is changing daily. A multidisciplinary team is required to address the challenge. Now and for the future.
Our dedicated team is a combination of experienced, skilled, and ambitious people who are experts in the field of artificial intelligence, cybersecurity, system engineering, and quantum physics.

### IoT Test Bed

Defense Mission Need: <<U.S Air Force Research Laboratory (Rome, NY)>> has a national defense-related mission need in the area of <<Advanced Battle Management Systems>>. Specifically, <<the need for interconnected IoT Testbed infrastructure to securely gather, process, and transmit data in mission-based scenarios. This will allow subjective risk assessments to be made with fused objective data, empowering the operators to make data-driven decisions, identify vulnerabilities, prevent cybersecurity attacks & proactively avoid and deter cybersecurity threats before they occur>>.
to build a functional IoT testbed architecture for our customer to test mission scenarios>>. The mission impact of this project on the Department of the Air Force and the Department of Defense will be <<to gather critical 5G and IoT data to make data-driven decisions and produce data-driven experimentation to create, refine, and adapt to mission needs in every situation.>>.

### Quantum Transmission Protocol

Quantum pocket adapts the type of protection it provides according to the threat that is happening.
Most commonly layers within systems are attacked differently. On the IMG file attached are the Blockchain attacks that the quantum pocket (and encapsulation) can protect any system from. Data, signals, etc.
Quantum encapsulation includes securing data, signals, metadata, NFTs, digital currency, and networks.
Quantum tunnel—hide your IP address and physical location while encrypting your internet traffic so that no one can tell who you are, where you are, or what you're doing online while protecting the transit information from quantum hacking
As the number of qubits increases, this speed increases exponentially compared to classical computers. Computations like data analytic, artificial intelligence which require large parallel processing ability can perform calculations in matter of milliseconds where it now takes ages to complete.
Non-Interactive Zero-Knowledge proofs (NIZKs) are a powerful building block in the design of Expressive cryptographic protocols such as anonymous credentials, anonymous survey systems, privacy-preserving digital currencies, and multi-party computation in general. Typically, NIZKs are used to defend against malicious parties and enforce honest behavior. Infiltron will use this in a few ways:
Use the quantum functions with Ai to speed up defense against malicious activities to the point of proactivity. More of an offensive approach to protecting the data and devices Infiltron is installed on.
Speed up verification of honest behavior while checking it for imposter tendencies. Ex. A malicious actor can disguise itself as a good actor . . . how do we determine this? Maybe assign hashes to existing ppl/data/devices that must be authenticated by Infiltron authorized verification system via an encryption process. And after new ppl/data/devices are introduced Infiltron assigns hashes with an encrypted key. OR utilized Zero-knowledge succinct non-interactive arguments of knowledge (zk-SNARK), a method of proving that something is true without revealing any other information. This method can be used for multi factor authentication/verification and accessing data/devices, while leveraging quantum for speed. This leads to the auditing functionality of Infiltron as well.
Infiltron will leverage the smartness of ML/DL to choose, according to the type of threat, data size, data classification, environments, person, device—which encryption algorithm is best to protect and/or transport system people data and devices. (need to train the model) https://www.newscientist.com/article/2134843-chinese-satellite-beats-distance-record-for-quantum-entanglement/
DDos Attacks have changed its strategy:
Infiltron detect when large packet volumes of data are being sent to servers, sourced IP addresses, IoT devices, hijacks of Hadoop clusters, attacks against databases and applications—(ISP/cloud provider of those), pulse waves, and outdated/poor security software installed on devices. Some of these attacks use bots, Infiltron will detect the bots. Pulse wave DDoS is a new attack tactic designed by skilled bad actors “to double the botnet's output and exploit soft spots in ‘appliance first cloud second’ hybrid mitigation solutions.”
   The left column lists encryption techniques that are subject to hacking by quantum computing. The right column lists encryption techniques that are not subject to hacking by quantum computing.

### Quantum Pocket

how the quantum pocket adapts the type of protection it provides according to the threat that is happening.
Most commonly layers within systems are attacked differently. On the IMG file attached are the Blockchain attacks that the quantum pocket (and encapsulation) can protect any system from. Data, signals, etc.
Quantum encapsulation includes securing data, signals, metadata, NFTs, digital currency, and networks.
Quantum tunnel—hide your IP address and physical location while encrypting your internet traffic so that no one can tell who you are, where you are, or what you're doing online while protecting the transit information from quantum hacking.
Anything in the system, commercial or military
data, signal
within the environment
civil not as hardened as military
un-secured systems and/or devices
code will be encapsulated to provide extra CS
   all blockchain will be encapsulated
malicious code injection
   For lifecycle cybersecurity to be built into hardware and software developments. This decreases vulnerability and risk once the development is complete.
   During development with cybersecurity being built in, development team can go back to implement new cybersecurity protection as new, innovative hacks pop up.
   It prevents malicious code injection during and post deployment. Ex. When software updates are pushed from hackers, it won't be able to affect the systems that sit inside of Infiltron's quantum encapsulation.
Quantum pocket—enables users regardless of location to communicate across data, blockchain, and telecommunication networks encapsulating the data with adaptive quantum cryptography to prevent quantum cyber attacks.
Determine which of the 3. quantum secure methods are best to protect data
   implementation is part of R&D
Providing cybersecurity protection when signal fails and falls over the next available means of communications. (spillover)
   If 5G fails, in redundancy, it goes 4g or LTE, UF, Infiltron will move with it to keep protected in real time.
      when preferred commo fails, and goes to secondary method
Entanglement of distant qubits possible
Colonial and quantum

### Facial Recognition Process

Take pictures facing forward and each side of face.
This image is compared against ethnic features of each of the 650 ethnic groups, known features of women, and hues of colors with artificial intelligence.
Mitigating issues around race and gender for women and people of color in biometric technology. Starting with facial recognition.
Our current pending patent detects hues of color.

### Who:

has similar technology to scale this fast
has the skills to develop this in house or someone in your network (preferably US citizens) if not, we can chat about it.
   Should there be a further qualification on low/poor quality images, because sometimes that one image might be all you get; maybe consider building an continuous biometric facial pattern database that allows the creation of facial landmarks even when data is subpar . . .
hue detecting
ethnic features
data correlating features and country of origin
building DB
positive ID of person
mitigate issues re race and gender and ableism (for healthcare, hiring practices, criminal justice, etc.)
   integration with DB
   update info re DB being accessed
      police/airports
Deep fakes
Biometric technology
   Body movements
   Vein pattern recognition
   Fingerprints
   Facial/voice recognition
   Iris scans

### Providing Cybersecurity and Racial Equality in Technology.

The Biometric System
   How the end user's biometrics will be used, secured, monitored, and if they are sharing it anywhere else.
   Test for bias accuracy frequently.
Migrating to Smart Ecosystems Using Biometric Technology
   Secure legacy migration practices needed.
   Hackers use hire info.
   Use real-time compliance/cybersecurity solutions or functions.
Global Government Enforcement.
   Biometric technologies must have racial bias mitigative functions built in or they will not be permitted to be sold or used.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A security system for implementing a threat characteristic recognition process in a computing environment, the security system configured to:
monitor data traffic at one or more access points of the computing environment;
provide the data to the security system as an input for analysis;
identify one or more characteristics of the data traffic;
compare the one or more characteristics of the data traffic to characteristics stored on one or more databases corresponding to suspicious or malicious behavior;
determine if the features are unauthorized actions or from an unauthorized actor based on the characteristics; and
prevent access to the system or transmission of the data if the one or more characteristics match with the characteristics stored on the one or more databases.

2. The security system of claim 1, wherein the one or more characteristics include a pattern or an anomaly in comparison to authentic behavior.

3. The security system of claim 1, wherein the one or more characteristics include a number of login attempts beyond a threshold number, a number of unsuccessful login attempts beyond a threshold number, a request for unauthorized data from an authorized user, or a request for an amount of data beyond a threshold amount.

4. The security system of claim 1, wherein the results of the comparisons of the one or more databases are cross-referenced to determine if the one or more characteristics is a match with any of the databases.

5. The security system of claim 1, wherein a match generates a positive identification report that includes details from each of the databases that contributed to the positive identification.

6. The security system of claim 1, wherein the method is configured to run on a client device or via one or more networked computing assets.

7. The security system of claim 1, wherein the method further comprises updating a database of the one or more databases when a comparison of the data results in a match.

8. The security system of claim 1, wherein the security system is connected to one or more internet of things (IoT) enabled devices including a camera or a client device.

9. The security system of claim 1, wherein the security system is operating on a quantum-enabled device or system.

10. The security system of claim 1, wherein the security system builds a machine learning algorithm to identify the one or more characteristics.
